(19) United States
(12) Patent Application Publication
(10) Pub. No.: US 2023/0178810 A1
(43) Pub. Date: Jun. 8, 2023

(54) ELECTROLYTE COMPOSITION FOR HIGH ENERGY DENSITY BATTERIES

(71) Applicant: GM GLOBAL TECHNOLOGY OPERATIONS LLC, Detroit, MI (US)

(72) Inventors: Meng Jiang, Rochester Hills, MI (US); Jiazhi Hu, Troy, MI (US)

(73) Assignee: GM GLOBAL TECHNOLOGY OPERATIONS LLC, Detroit, MI (US)

(21) Appl. No.: 17/541,415

(22) Filed: Dec. 3, 2021

(51) Int. Cl. H01M 10/0569; H01M 10/0567; H01M 10/0568; H01M 4/587; H01M 4/525; H01M 10/0525; H01M 4/505

(52) U.S. Cl. CPC H01M 10/0569; H01M 10/0567; H01M 10/0568; H01M 4/587; H01M 4/525; H01M 10/0525; H01M 4/505; H01M 2300/004

(57) ABSTRACT

An electrolyte composition for batteries is provided. The electrolyte composition includes ethylene carbonate, diethyl carbonate, ethyl methyl carbonate, vinyl ethylene carbonate, vinyl carbonate, 1,3-propane sultone, ethylene sulfate, and lithium difluorophosphate. The ethylene carbonate, the diethyl carbonate, and the ethyl methyl carbonate are each present in the electrolyte composition in an amount from 10 parts by weight to 50 parts by weight based on 100 parts by weight of the electrolyte composition. The vinyl ethylene carbonate is present in an amount up to 0.5 parts by weight based on 100 parts by weight of the electrolyte composition. The vinyl carbonate is present in an amount up to 1.0 parts by weight based on 100 parts by weight of the electrolyte composition. The 1,3-propane sultone is present in an amount up to 1.5 parts by weight based on 100 parts by weight of the electrolyte composition.

### INTRODUCTION

The disclosure generally relates to an electrolyte composition for batteries.

Battery cells may include an anode, a cathode, an electrolyte composition, and a separator. A battery cell may operate in charge mode, receiving electrical energy. A battery cell may operate in discharge mode, providing electrical energy. A battery cell may operate through charge and discharge cycles, where the battery first receives and stores electrical energy and then provides electrical energy to a connected system. In vehicles utilizing electrical energy to provide motive force, battery cells of the vehicle may be charged, and then the vehicle may navigate for a period of time, utilizing the stored electrical energy to generate motive force.

A battery cell includes an electrolyte composition which provides lithium-ion conduction paths between the anode and the cathode. The electrolyte is an ionic conductor. The electrolyte is additionally an electronically insulating material.

### SUMMARY

An electrolyte composition for batteries is provided. The electrolyte composition includes ethylene carbonate, diethyl carbonate, ethyl methyl carbonate, vinyl ethylene carbonate, vinyl carbonate, 1,3-propane sultone, ethylene sulfate, and lithium difluorophosphate. The ethylene carbonate, the diethyl carbonate, and the ethyl methyl carbonate are each present in the electrolyte composition in an amount from 10 parts by weight to 50 parts by weight based on 100 parts by weight of the electrolyte composition. The vinyl ethylene carbonate is present in the electrolyte composition in an amount up to 0.5 parts by weight based on 100 parts by weight of the electrolyte composition. The vinyl carbonate is present in the electrolyte composition in an amount up to 1.0 parts by weight based on 100 parts by weight of the electrolyte composition. The 1,3-propane sultone is present in the electrolyte composition in an amount up to 1.5 parts by weight based on 100 parts by weight of the electrolyte composition.

In some embodiments, the ethylene sulfate is present in the electrolyte composition in at least 0.95 parts by weight based on 100 parts by weight of the electrolyte composition.

In some embodiments, the ethylene sulfate is present in the electrolyte composition in an amount up to 1.05 parts by weight based on 100 parts by weight of the electrolyte composition.

In some embodiments, the ethylene sulfate is present in the electrolyte composition in an amount from 0.95 parts by weight to 1.05 parts by weight based on 100 parts by weight of the electrolyte composition.

In some embodiments, the lithium difluorophosphate is present in the electrolyte composition in at least 0.5 parts by weight based on 100 parts by weight of the electrolyte composition.

In some embodiments, the lithium difluorophosphate is present in the electrolyte composition in at least 0.1 parts by weight based on 100 parts by weight of the electrolyte composition.

In some embodiments, the lithium difluorophosphate is present in the electrolyte composition in an amount from 0.5 parts by weight to 1.5 parts by weight based on 100 parts by weight of the electrolyte composition.

In some embodiments, the lithium difluorophosphate is present in the electrolyte composition in an amount from 0.1 parts by weight to 1.5 parts by weight based on 100 parts by weight of the electrolyte composition.

In some embodiments, the ethylene sulfate is present in the electrolyte composition in an amount from 0.95 parts by weight to 1.05 parts by weight based on 100 parts by weight of the electrolyte composition. The lithium difluorophosphate is present in the electrolyte composition in an amount from 0.1 parts by weight to 1.5 parts by weight based on 100 parts by weight of the electrolyte composition.

In some embodiments, the ethylene carbonate, the diethyl carbonate, and the ethyl methyl carbonate are present in a 1:1:1 ratio. The vinyl ethylene carbonate is present in the electrolyte composition in 0.5 parts by weight based on 100 parts by weight of the electrolyte composition. The vinyl carbonate is present in the electrolyte composition in 1.0 parts by weight based on 100 parts by weight of the electrolyte composition. The 1,3-propane sultone is present in the electrolyte composition in 1.5 parts by weight based on 100 parts by weight of the electrolyte composition.

According to one alternative embodiment, a battery including an electrolyte composition is provided. The battery includes a graphite anode, a nickel-based cathode, and the electrolyte composition. The electrolyte composition includes ethylene carbonate, diethyl carbonate, ethyl methyl carbonate, vinyl ethylene carbonate, vinyl carbonate, 1,3-propane sultone, ethylene sulfate, and lithium difluorophosphate. The ethylene carbonate, the diethyl carbonate, and the ethyl methyl carbonate are each present in the electrolyte composition in an amount from 10 parts by weight to 50 parts by weight based on 100 parts by weight of the electrolyte composition. The vinyl ethylene carbonate is present in the electrolyte composition in an amount up to 0.5 parts by weight based on 100 parts by weight of the electrolyte composition. The vinyl carbonate is present in the electrolyte composition in an amount up to 1.0 parts by weight based on 100 parts by weight of the electrolyte composition. The 1,3-propane sultone is present in the electrolyte composition in an amount up to 1.5 parts by weight based on 100 parts by weight of the electrolyte composition.

In some embodiments, the ethylene sulfate is present in the electrolyte composition in at least 0.95 parts by weight based on 100 parts by weight of the electrolyte composition.

In some embodiments, the lithium difluorophosphate is present in the electrolyte composition in at least 0.1 parts by weight based on 100 parts by weight of the electrolyte composition.

In some embodiments, the ethylene sulfate is present in the electrolyte composition in an amount from 0.95 parts by weight to 1.05 parts by weight based on 100 parts by weight of the electrolyte composition. The lithium difluorophosphate is present in the electrolyte composition in an amount from 0.1 parts by weight to 1.5 parts by weight based on 100 parts by weight of the electrolyte composition.

In some embodiments, the ethylene carbonate, the diethyl carbonate, and the ethyl methyl carbonate are present in a 1:1:1 ratio. The vinyl ethylene carbonate is present in the electrolyte composition in 0.5 parts by weight based on 100 parts by weight of the electrolyte composition. The vinyl carbonate is present in the electrolyte composition in 1.0 parts by weight based on 100 parts by weight of the electrolyte composition. The 1,3-propane sultone is present in the electrolyte composition in 1.5 parts by weight based on 100 parts by weight of the electrolyte composition.

According to one alternative embodiment, a device is provided. The device includes an output component and a battery configured for providing electrical energy to the output component. The battery includes a graphite anode, a nickel-based cathode, and an electrolyte composition. The electrolyte composition includes ethylene carbonate, diethyl carbonate, ethyl methyl carbonate, vinyl ethylene carbonate, vinyl carbonate, 1,3-propane sultone, ethylene sulfate, and lithium difluorophosphate. The ethylene carbonate, the diethyl carbonate, and the ethyl methyl carbonate are each present in the electrolyte composition in an amount from 10 parts by weight to 50 parts by weight based on 100 parts by weight of the electrolyte composition. The vinyl ethylene carbonate is present in the electrolyte composition in an amount up to 0.5 parts by weight based on 100 parts by weight of the electrolyte composition. The vinyl carbonate is present in the electrolyte composition in an amount up to 1.0 parts by weight based on 100 parts by weight of the electrolyte composition. The 1,3-propane sultone is present in the electrolyte composition in an amount up to 1.5 parts by weight based on 100 parts by weight of the electrolyte composition.

In some embodiments, the ethylene sulfate is present in the electrolyte composition in at least 0.95 parts by weight based on 100 parts by weight of the electrolyte composition.

In some embodiments, the lithium difluorophosphate is present in the electrolyte composition in at least 0.1 parts by weight based on 100 parts by weight of the electrolyte composition.

In some embodiments, the ethylene sulfate is present in the electrolyte composition in an amount from 0.95 parts by weight to 1.05 parts by weight based on 100 parts by weight of the electrolyte composition. The lithium difluorophosphate is present in the electrolyte composition in an amount from 0.1 parts by weight to 1.5 parts by weight based on 100 parts by weight of the electrolyte composition.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 schematically illustrates an exemplary battery cell including an anode, a cathode, a separator, and an electrolyte composition, in accordance with the present disclosure;

FIG. 2 schematically illustrates an exemplary device including a battery pack including a plurality of battery cells, in accordance with the present disclosure;

FIG. 3 is a graph illustrating exemplary test results of a relationship between capacity retention of a battery cell and a number of charge/discharge cycles through which the battery cell is operated, in accordance with the present disclosure;

FIG. 4 is a chart illustrating exemplary test results comparing normalized capacity of a battery cell in a charging cycle versus a number of charge/discharge cycles through which the battery cell is operated, in accordance with the present disclosure;

FIG. 5 is a chart illustrating exemplary test results comparing normalized capacity of a battery cell in a discharging cycle versus a number of charge/discharge cycles through which the battery cell is operated, in accordance with the present disclosure; and

FIG. 6 is a graph illustrating exemplary test results comparing capacity retention of a plurality of battery cells versus a number of charge/discharge cycles through which the battery cells are operated, with the plurality of battery cells including different concentrations of LiPO₂F₂ added to the electrolyte, in accordance with the present disclosure.

### DETAILED DESCRIPTION

High-capacity and high-power nickel-based cathode materials are useful for a lithium-ion energy storage system powering a battery electric vehicle. Such an energy storage system may be described as a high energy density battery. The battery cells may include a graphite anode and a nickel-based cathode.

A capacity and cycling tolerance of the battery cells may vary according to operating conditions. Battery cell performance may vary according to cathode and anode material selection. An electrolyte composition disclosed herein provides excellent cycle life for the battery cells. In one embodiment, the electrolyte may include ethylene carbonate (EC)/diethyl carbonate (DEC)/ethyl methyl carbonate (EMC) in a 1:1:1 ratio. The electrolyte may further include vinyl ethylene carbonate (VEC) at 0.5% by weight, vinyl carbonate (VC) at 1% by weight, and 1,3-propane sultone (PS) at 1.5% by weight. The electrolyte includes excellent cycle performance by further including ethylene sulfate (DTD) at between 0.1% by weight and 1.0% by weight and by further including lithium difluorophosphate (LiPO₂F₂) at between 0.1% by weight and 1.5% by weight. In some embodiments, the DTD may be added at between 0.5% by weight and 1.0% by weight. In some embodiments, the LiPO₂F₂ may be added at between 0.5% by weight and 1.5% by weight.

Testing has shown that addition of DTD and LiPO₂F₂ in the described weight percentages improves solid electrolyte interface (SEI) formation on the anode and forms an excellent preservation layer upon both the cathode and the anode. An SEI may form upon a surface of an anode. An SEI results from a chemical reaction between the anode and a liquid or gel electrolyte interacting with the anode. The SEI forms as a film upon the anode.

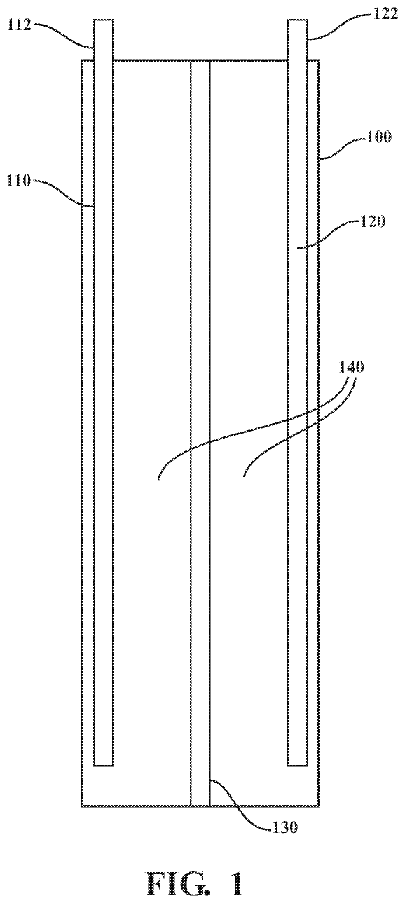

Referring now to the drawings, wherein like reference numbers refer to like features throughout the several views, FIG. 1 schematically illustrates an exemplary battery cell 100, including an anode 110, a cathode 120, a separator 130, and an electrolyte composition 140. The battery cell 100 enables converting electrical energy into stored chemical energy in a charging cycle, and the battery cell 100 enable converting stored chemical energy into electrical energy in a discharging cycle. A negative current collector 112 is illustrated connected to the anode 110, and a positive current collector 122 is illustrated connected to the cathode 120. The separator 130 is operable to separate the anode 110 from the cathode 120 and to enable ion transfer through the separator 130. The electrolyte composition 140 is a liquid or gel that provides a lithium-ion conduction path between the anode 110 and the cathode 120.

The anode 110 may be constructed of graphite. The cathode 120 may be constructed of a nickel-based substance. In one embodiment, the cathode 120 may be constructed of a nickel manganese cobalt (NMC) substance.

The electrolyte composition 140 may include EC/DEC/EMC in a 1:1:1 composition. The electrolyte composition 140 may include variations in the 1:1:1 composition, with each of the EC, DEV, and EMC being present in a range between 10% and 50% by weight. The electrolyte composition 140 may further include VEC at 0.5% by weight, VC at 1% by weight, and PS at 1.5% by weight. The electrolyte composition 140 may include variations in the presence of VEC, VC, and PS, with the VEC being present at up to 0.5% by weight, with the VC being present at up to 1% by weight, and with the PS being present at up to 1.5% by weight. The electrolyte provides excellent cycle performance by further including DTD at between 0.1% by weight and 1.0% by weight and by further including LiPO₂F₂ at between 0.1% by weight and 1.5% by weight. In some embodiments, the DTD may be added at between 0.5% by weight and 1.0% by weight. In some embodiments, the LiPO₂F₂ may be added at between 0.5% by weight and 1.5% by weight.

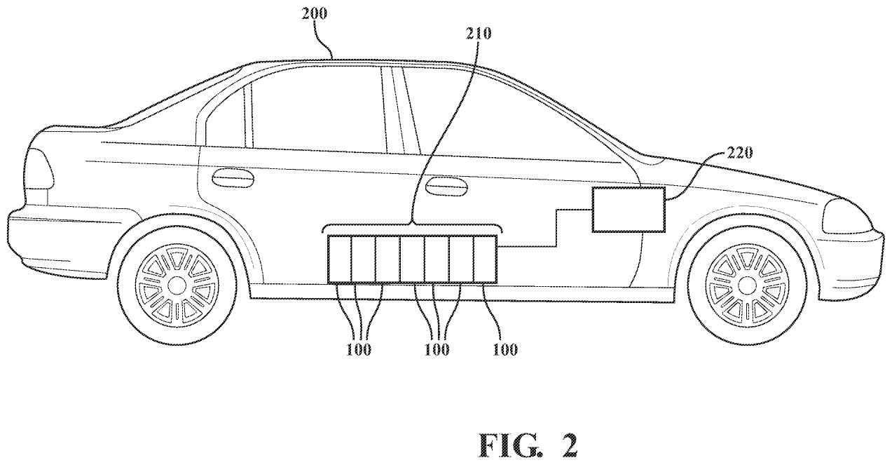

The battery cell 100 may be utilized in a wide range of applications and powertrains. FIG. 2 schematically illustrates an exemplary device 200, e.g., a battery electric vehicle (BEV), including a battery pack 210 that includes a plurality of battery cells 100. The plurality of battery cells 100 may be connected in various combinations, for example, with a portion being connected in parallel and a portion being connected in series, to achieve goals of supplying electrical energy at a desired voltage. The battery pack 210 is illustrated as electrically connected to a motor generator unit 220 useful to provide motive force to the vehicle 200. The motor generator unit 220 may include an output component, for example, an output shaft, which is provided mechanical energy useful to provide the motive force to the vehicle 200. A number of variations to vehicle 200 are envisioned, and the disclosure is not intended to be limited to the examples provided.

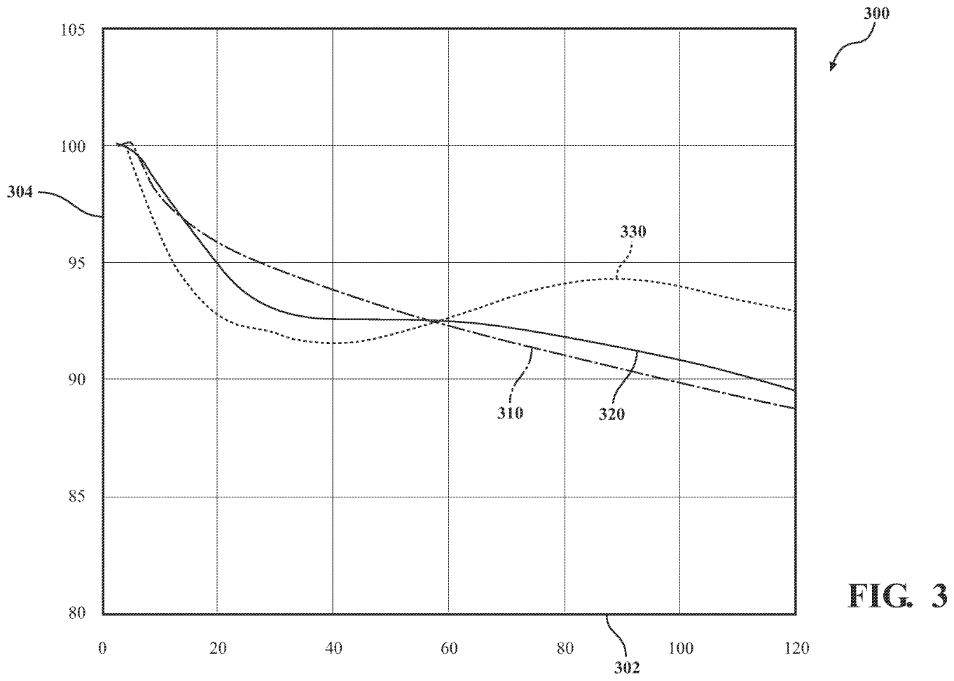

FIG. 3 is a graph 300 illustrating exemplary test results of a relationship between capacity retention of a battery cell and a number of charge/discharge cycles through which the battery cell is operated. A vertical axis 304 is illustrated describing a capacity retention of the tested battery cell as a percentage of an original battery capacity. A horizontal axis 302 is illustrated describing the number of charge/discharge cycles. Plot 310 illustrates the electrolyte composition 140 of FIG. 1 without either a DTD or LiPO₂F₂ additive. Plot 320 illustrates the electrolyte composition 140 of FIG. 1 with DTD added. Plot 330 illustrates the electrolyte composition 140 of FIG. 1 with LiPO₂F₂ added. One may see that both the DTD and the LiPO₂F₂ significantly enhance the battery cell cycling performance, with the battery cells tested retaining excellent capacity over increasing numbers of charge/discharge cycles.

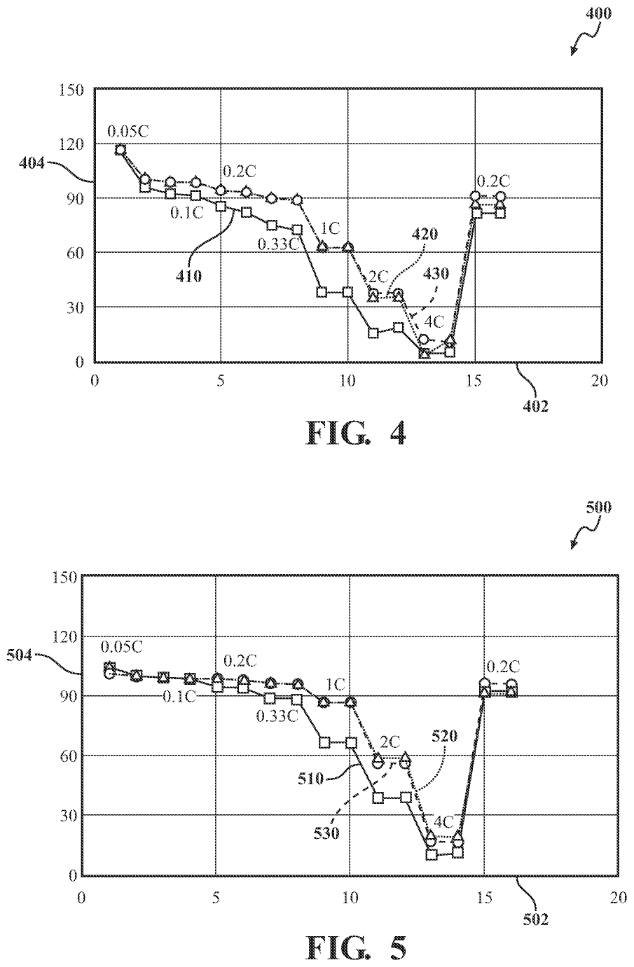

FIG. 4 is a chart 400 illustrating exemplary test results comparing normalized capacity of a battery cell in a charging cycle versus a number of charge/discharge cycles through which the battery cell is operated. A vertical axis 404 is illustrated describing a normalized capacity of the tested battery cell as a percentage. The normalized capacity is defined as a ratio between the capacity of the current cycle versus the capacity of the initial cycle. A horizontal axis 402 is illustrated describing the number of charge/discharge cycles. Plot 410 illustrates the electrolyte composition 140 of FIG. 1 without either a DTD or LiPO₂F₂ additive. Plot 420 illustrates the electrolyte composition 140 of FIG. 1 with DTD added. Plot 430 illustrates the electrolyte composition 140 of FIG. 1 with LiPO₂F₂ added. FIG. 5 is a chart 500 illustrating exemplary test results comparing normalized capacity of a battery cell in a discharging cycle versus a number of charge/discharge cycles through which the battery cell is operated. A vertical axis 504 is illustrated describing a normalized capacity of the tested battery cell as a percentage. A horizontal axis 502 is illustrated describing the number of charge/discharge cycles. Plot 510 illustrates the electrolyte composition 140 of FIG. 1 without either a DTD or LiPO₂F₂ additive. Plot 520 illustrates the electrolyte composition 140 of FIG. 1 with DTD added. Plot 530 illustrates the electrolyte composition 140 of FIG. 1 with LiPO₂F₂ added. One may see in FIGS. 4 and 5 that both the DTD and the LiPO₂F₂ significantly enhance the battery cell cycling performance, with the battery cells tested retaining excellent normalized capacity over increasing numbers of charge/discharge cycles.

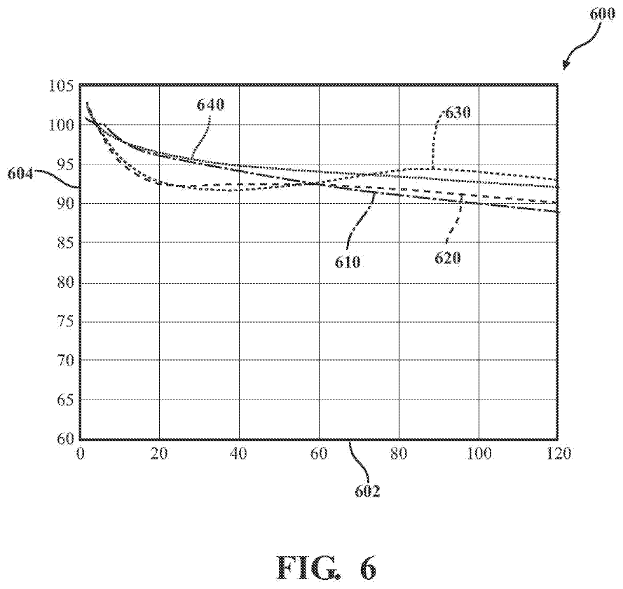

FIG. 6 is a graph 600 illustrating exemplary test results comparing capacity retention of a plurality of battery cells versus a number of charge/discharge cycles through which the battery cells are operated, with the plurality of battery cells including different concentrations of LiPO₂F₂ added to the electrolyte for purposes of comparison. A vertical axis 604 is illustrated describing a capacity retention of the tested battery cell as a percentage of an original battery capacity. A horizontal axis 602 is illustrated describing the number of charge/discharge cycles. Plot 610 illustrates the electrolyte composition 140 of FIG. 1 without either a DTD or LiPO₂F₂ additive. Plot 620 illustrates the electrolyte composition 140 of FIG. 1 with LiPO₂F₂ added at 0.5% by weight. Plot 630 illustrates the electrolyte composition 140 of FIG. 1 with LiPO₂F₂ added at 1.0% by weight. Plot 640 illustrates the electrolyte composition 140 of FIG. 1 with LiPO₂F₂ added at 1.5% by weight. LiPO₂F₂ added may be added in a selected amount based upon desired properties of the electrolyte composition 140.

While the best modes for carrying out the disclosure have been described in detail, those familiar with the art to which this disclosure relates will recognize various alternative designs and embodiments for practicing the disclosure within the scope of the appended claims.

What is claimed is:

1. An electrolyte composition for batteries, the electrolyte composition comprising:
ethylene carbonate;
diethyl carbonate;
ethyl methyl carbonate;
vinyl ethylene carbonate;
vinyl carbonate;
1,3-propane sultone;
ethylene sulfate; and
lithium difluorophosphate; and
wherein the ethylene carbonate, the diethyl carbonate, and the ethyl methyl carbonate are each present in the electrolyte composition in an amount from 10 parts by weight to 50 parts by weight based on 100 parts by weight of the electrolyte composition;
wherein the vinyl ethylene carbonate is present in the electrolyte composition in an amount up to 0.5 parts by weight based on 100 parts by weight of the electrolyte composition;
wherein the vinyl carbonate is present in the electrolyte composition in an amount up to 1.0 parts by weight based on 100 parts by weight of the electrolyte composition; and
wherein the 1,3-propane sultone is present in the electrolyte composition in an amount up to 1.5 parts by weight based on 100 parts by weight of the electrolyte composition.

2. The electrolyte composition of claim 1, wherein the ethylene sulfate is present in the electrolyte composition in at least 0.95 parts by weight based on 100 parts by weight of the electrolyte composition.

3. The electrolyte composition of claim 2, wherein the ethylene sulfate is present in the electrolyte composition in an amount up to 1.05 parts by weight based on 100 parts by weight of the electrolyte composition.

4. The electrolyte composition of claim 1, wherein the ethylene sulfate is present in the electrolyte composition in an amount from 0.95 parts by weight to 1.05 parts by weight based on 100 parts by weight of the electrolyte composition.

5. The electrolyte composition of claim 1, wherein the lithium difluorophosphate is present in the electrolyte composition in at least 0.5 parts by weight based on 100 parts by weight of the electrolyte composition.

6. The electrolyte composition of claim 5, wherein the lithium difluorophosphate is present in the electrolyte composition in at least 0.1 parts by weight based on 100 parts by weight of the electrolyte composition.

7. The electrolyte composition of claim 1, wherein the lithium difluorophosphate is present in the electrolyte composition in an amount from 0.5 parts by weight to 1.5 parts by weight based on 100 parts by weight of the electrolyte composition.

8. The electrolyte composition of claim 1, wherein the lithium difluorophosphate is present in the electrolyte composition in an amount from 0.1 parts by weight to 1.5 parts by weight based on 100 parts by weight of the electrolyte composition.

9. The electrolyte composition of claim 1, wherein the ethylene sulfate is present in the electrolyte composition in an amount from 0.95 parts by weight to 1.05 parts by weight based on 100 parts by weight of the electrolyte composition; and
wherein the lithium difluorophosphate is present in the electrolyte composition in an amount from 0.1 parts by weight to 1.5 parts by weight based on 100 parts by weight of the electrolyte composition.

10. The electrolyte composition of claim 1, wherein the ethylene carbonate, the diethyl carbonate, and the ethyl methyl carbonate are present in a 1:1:1 ratio;
wherein the vinyl ethylene carbonate is present in the electrolyte composition in 0.5 parts by weight based on 100 parts by weight of the electrolyte composition;
wherein the vinyl carbonate is present in the electrolyte composition in 1.0 parts by weight based on 100 parts by weight of the electrolyte composition; and
wherein the 1,3-propane sultone is present in the electrolyte composition in 1.5 parts by weight based on 100 parts by weight of the electrolyte composition.

11. A battery including an electrolyte composition, the battery comprising:
a graphite anode;
a nickel-based cathode; and
the electrolyte composition, including:
ethylene carbonate;
diethyl carbonate;
ethyl methyl carbonate;
vinyl ethylene carbonate;
vinyl carbonate;
1,3-propane sultone;
ethylene sulfate; and
lithium difluorophosphate; and
wherein the ethylene carbonate, the diethyl carbonate, and the ethyl methyl carbonate are each present in the electrolyte composition in an amount from 10 parts by weight to 50 parts by weight based on 100 parts by weight of the electrolyte composition;
wherein the vinyl ethylene carbonate is present in the electrolyte composition in an amount up to 0.5 parts by weight based on 100 parts by weight of the electrolyte composition;
wherein the vinyl carbonate is present in the electrolyte composition in an amount up to 1.0 parts by weight based on 100 parts by weight of the electrolyte composition; and
wherein the 1,3-propane sultone is present in the electrolyte composition in an amount up to 1.5 parts by weight based on 100 parts by weight of the electrolyte composition.

12. The battery of claim 11, wherein the ethylene sulfate is present in the electrolyte composition in at least 0.95 parts by weight based on 100 parts by weight of the electrolyte composition.

13. The battery of claim 11, wherein the lithium difluorophosphate is present in the electrolyte composition in at least 0.1 parts by weight based on 100 parts by weight of the electrolyte composition.

14. The battery of claim 11, wherein the ethylene sulfate is present in the electrolyte composition in an amount from 0.95 parts by weight to 1.05 parts by weight based on 100 parts by weight of the electrolyte composition; and
wherein the lithium difluorophosphate is present in the electrolyte composition in an amount from 0.1 parts by weight to 1.5 parts by weight based on 100 parts by weight of the electrolyte composition.

15. The battery of claim 11, wherein the ethylene carbonate, the diethyl carbonate, and the ethyl methyl carbonate are present in a 1:1:1 ratio;
wherein the vinyl ethylene carbonate is present in the electrolyte composition in 0.5 parts by weight based on 100 parts by weight of the electrolyte composition;
wherein the vinyl carbonate is present in the electrolyte composition in 1.0 parts by weight based on 100 parts by weight of the electrolyte composition; and
wherein the 1,3-propane sultone is present in the electrolyte composition in 1.5 parts by weight based on 100 parts by weight of the electrolyte composition.

16. A device comprising:
an output component; and
a battery configured for providing electrical energy to the output component, the battery including:
a graphite anode;
a nickel-based cathode; and
an electrolyte composition including:
ethylene carbonate;
diethyl carbonate;
ethyl methyl carbonate;
vinyl ethylene carbonate;
vinyl carbonate;
1,3-propane sultone;
ethylene sulfate; and
lithium difluorophosphate; and
wherein the ethylene carbonate, the diethyl carbonate, and the ethyl methyl carbonate are each present in the electrolyte composition in an amount from 10 parts by weight to 50 parts by weight based on 100 parts by weight of the electrolyte composition;
wherein the vinyl ethylene carbonate is present in the electrolyte composition in an amount up to 0.5 parts by weight based on 100 parts by weight of the electrolyte composition;
wherein the vinyl carbonate is present in the electrolyte composition in an amount up to 1.0 parts by weight based on 100 parts by weight of the electrolyte composition; and
wherein the 1,3-propane sultone is present in the electrolyte composition in an amount up to 1.5 parts by weight based on 100 parts by weight of the electrolyte composition.

17. The vehicle of claim 16, wherein the ethylene sulfate is present in the electrolyte composition in at least 0.95 parts by weight based on 100 parts by weight of the electrolyte composition.

18. The vehicle of claim 16, wherein the lithium difluorophosphate is present in the electrolyte composition in at least 0.1 parts by weight based on 100 parts by weight of the electrolyte composition.

19. The vehicle of claim 16, wherein the ethylene sulfate is present in the electrolyte composition in an amount from 0.95 parts by weight to 1.05 parts by weight based on 100 parts by weight of the electrolyte composition; and
wherein the lithium difluorophosphate is present in the electrolyte composition in an amount from 0.1 parts by weight to 1.5 parts by weight based on 100 parts by weight of the electrolyte composition.
